(19) United States
(12) Patent Application Publication
(10) Pub. No.: US 2011/0320926 A1
(43) Pub. Date: Dec. 29, 2011

(54) GENERATING XML SCHEMAS FOR XML DOCUMENT

(75) Inventors: Vinay Agarwal, Bangalore (IN); Nithin Kovoor, Bangalore (IN)

(73) Assignee: Oracle International Corporation, Redwood Shores, CA (US)

(21) Appl. No.: 12/824,977

(22) Filed: Jun. 28, 2010

(51) Int. Cl. G06F 17/00

(52) U.S. Cl. 715/234

(57) ABSTRACT

The present invention is directed to implementing methods and systems for automatically defining XML document rules by generating an XML schema for a given XML document to an extent that the schema can be generated without human intervention. Further, developers working on XML technologies are benefited by this solution as it provides a simple way of generating a skeletal schema based on an XML document. The XML document based on which the schema is to be generated may be well formed and can use a namespace. Generation of the schema may include the following three phases: 1) Gathering information, 2) Parsing the XML document, and 3) Building the schema.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

Presently, in order to generate a schema for an XML (or similar) document, a labor-intensive manual process must be performed by a human actor. Further, XML files alone are not the complete answer to avoiding the problems associated with fixed length or delimited text files. Unless an XML schema that defines the XML file exists, the XML file is merely a text file with a bit more information. For example, if one data element in the text files changes or is incorrect, the application using the XML will crash or not function properly. As such, an XML schema defines what data is expected in the XML text file (such a schema is very valuable to applications and application developers).

Accordingly, the application will be made aware ahead of time of what data is coming, and what the data should look like. In a real world scenario the data is directly input into the XML document and it then becomes very difficult and time-consuming to define the rules placed on the data with regard to the XML document. Hence, improved rating and ranking methods and systems are needed in the art.

### SUMMARY OF THE INVENTION

The present invention is directed to implementing methods and systems for automatically defining XML document rules by generating an XML schema for a given XML document to an extent that the schema can be generated without human intervention. Further, developers working on XML technologies are benefited by this solution as it provides a simple way of generating a skeletal schema based on an XML document. The XML document based on which the schema is to be generated may be well formed and can use a namespace. Generation of the schema may include the following three phases: 1) Gathering information, 2) Parsing the XML document, and 3) Building the schema.

### BRIEF DESCRIPTION OF THE DRAWINGS

FIG. 1A is a simplified flow diagram illustrating a method for gathering information from an XML document, according to an embodiment of the present invention.

FIG. 1B is one example of a user interface for gathering information from the XML document, according to an embodiment of the present invention.

FIG. 2 is a simplified flow diagram illustrating a method for parsing the XML document, according to an embodiment of the present invention.

FIG. 3 is a simplified flow diagram illustrating a method for building an XML schema, according to an embodiment of the present invention.

FIG. 4 is a simplified block diagram illustrating a system for implementing aspects of the present invention, according to a further embodiment of the present invention.

FIG. 5 is a simplified block diagram illustrating physical components of a system environment 500 that may be used in accordance with an embodiment of the present invention.

FIG. 6 is a simplified block diagram illustrating the physical components of a computer system 600 that may be used in accordance with an embodiment of the present invention.

### DETAILED DESCRIPTION OF THE INVENTION

The present invention is directed to implementing methods and systems for automatically defining XML document rules by generating an XML schema for a given XML document to an extent that the schema can be generated without human intervention. Further, developers working on XML technologies are benefited by this solution as it provides a simple way of generating a skeletal schema based on an XML document. The XML document based on which the schema is to be generated may be well formed and can use a namespace. Generation of the schema may include the following three phases: 1) Gathering information, 2) Parsing the XML document, and 3) Building the schema.

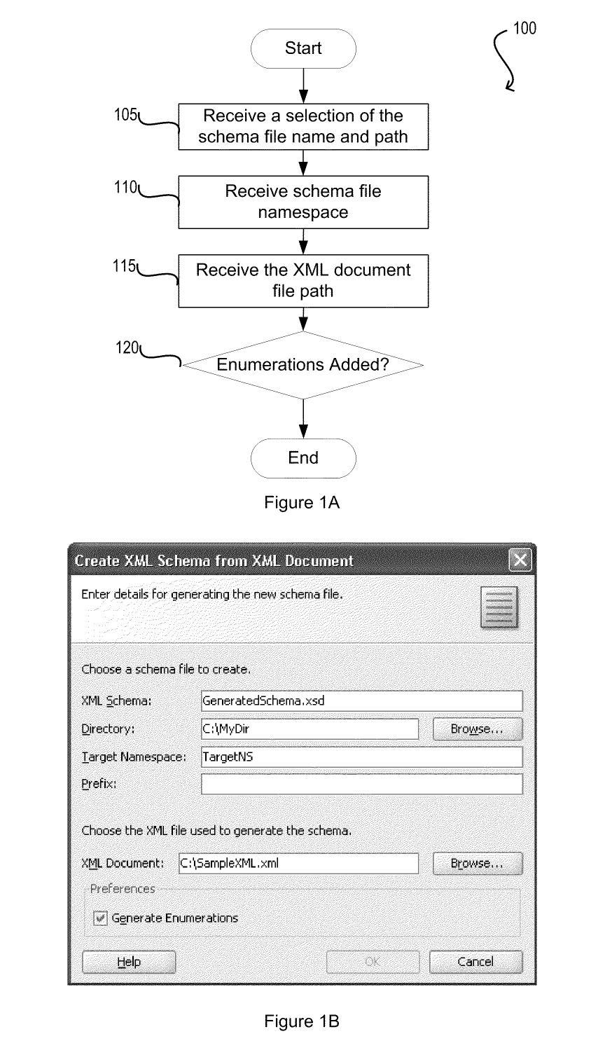

Turning now to FIG. 1A, which illustrates method 100 for gathering information from an XML document, according to an embodiment of the present invention. At process block 105, a selection of the schema file name and path is received. In one embodiment, the selection may be received through a user interface (e.g., the user interface in FIG. 1B). The schema file name may be automatically generated or alternatively may be generated by a user or administrator. Furthermore, the path includes the location of where the schema file is to be stored on a storage device.

At process block 110, the schema file's namespace may be received. If a namespace is not provided, then the namespace of the XML document may be used. Further, the XML document's file path may be received using the user interface (process block 115). In one embodiment, the XML document may include multiple tags and associated character information. Further, the XML document may include root elements and one or more child elements.

At process block 120, a determination may be made whether enumerations are to be added to the schema file. In one embodiment, the enumerations may include an indication that all possible values for each element are to be considered. Additional and alternative options may be received at the user interface. For example, as can be seen in FIG. 1B, the user interface may include a prefix for the XML schema. Namespaces are like containers to hold the definitions of element and attribute names. These namespaces may be referred to in the XML document using their full URI reference or a unique identifier called a prefix which is defined in the namespace declaration. As such, each prefix is bound to one and only one namespace name.

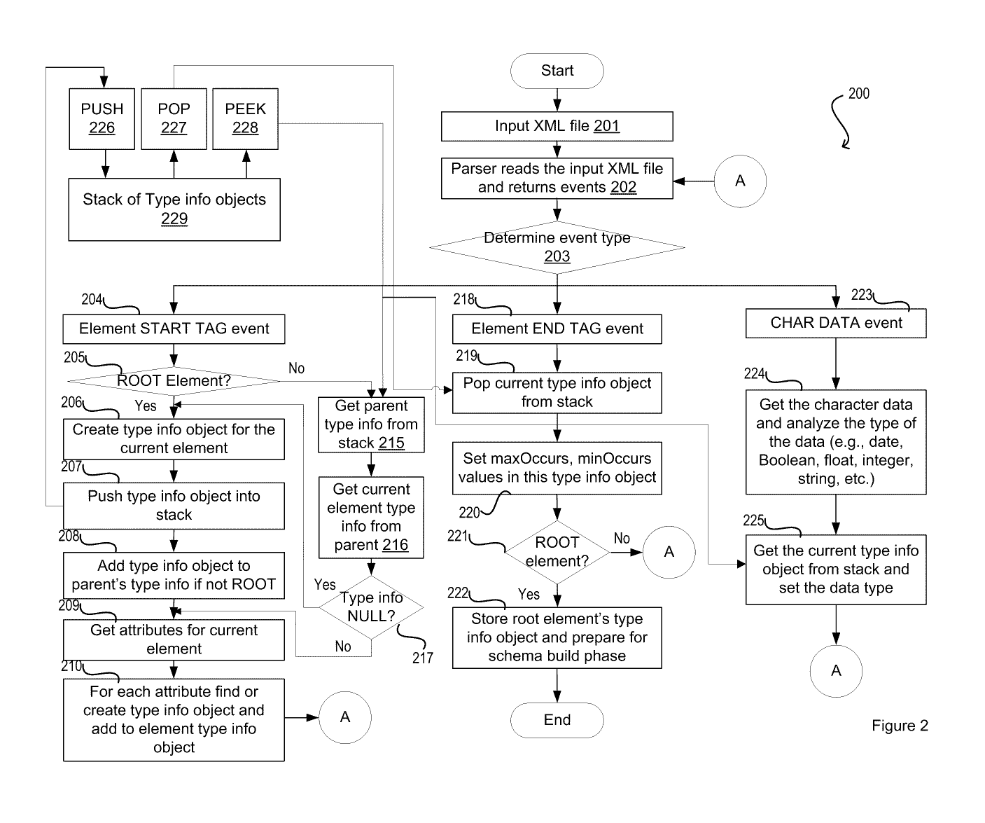

Turning next to FIG. 2, which illustrates a method 200 for parsing the XML document, according to an embodiment of the present invention. In one embodiment, the XML document may be parsed using a SAX parser, or other suitable parser. As such, information about the nodes included in the XML document may be extracted and stored as type information objects. These type information objects may then be used to generate the XML schema. The type of text may be recognized against rules for DATE, INTEGER, FLOAT, STRING, etc. The type information objects store all of the information about the node. For example, the node's name, a list of the node's children, the type of the text (if present), etc.

At process block 201, the XML document is input into the parser. At process block 202, the parser reads the inputted XML document and returns events. In one embodiment, the events may include an event type. For example, the event type may include a START TAG event, an END TAG event, or CHAR DATA event. Below is one example of a possible XML document, however, alternative XML document configurations may be used.

```
<employees orgName=”My Org”>
  <employee>
    <name firstName=”Scott” lastName=”Tiger”/>
      <hiredate>01-jan-2010</hiredate>
      <salary>1000.00</salary>
      <age>30</age>
    </employee>
  </employees>
```

As such, at decision block 203, a determination of the parsed event's event type is made. If the event type is determined to be a START TAG event, then the process moves to process block 204. Accordingly, at decision block 205, a determination is made whether the current event is a ROOT element. If the current event is a ROOT element, then at process block 206, a type information object for the current element is created. The newly created type information object is then pushed 226 to the stack of type information objects 229 (process block 207). At process block 209, the type information object is added to its parent's type information object (only if the current element is not a ROOT element). As such, for the first element (i.e., the ROOT element), process block 208 is not performed.

Turning back to decision block 205, determining that the current element is not a ROOT element. As such, the process continues to process block 215. At process block 215, the parent type information object for the current element is popped 227 from stack 229. Then, at process block 216, the current element's type information object is retrieved form the parent type information object.

At decision block 217, it is determined if the type information object retrieved from the parent type information object is NULL. If the retrieved type information object is NULL, then the process returns to process block 206 in order to create a new type information object for the current element, and push 226 the created type information object onto stack 229 (i.e., process blocks 206-208).

If it is determined that the retrieved type information object is not NULL, then the process moves to process block 209 (i.e., skipping process block 206-208 due to the fact that a type information object has already been created and pushed to the stack 229). At process block 209, attributes for the current element are extracted. Then, for each attribute, a type information object is either created or found and then added to the current type information object. Thus, for each type information object, all of the attributes of the current type information object are created as type information objects, which are subordinate to the current type information object.

Accordingly, the process continues to point A. At point A, the parser continues to read the input XML document, and return events (process block 202). At process block 203, it is determined that the returned event is an END TAG event (process block 219). Accordingly, at process block 219, the current type information object is popped 227 from the stack 229. Then at process block 220, a maximum occurrence (maxOccurs) value and a minimum occurrence (minOccurs) value are set for the current type information object. In one embodiment, the maximum number of times an element may appear is determined by the value of the maxOccurs attribute in its declaration. The minimum number of times an element may appear is determined by the value of the minOccurs attribute.

At decision block 221, a determination is made whether the current element is the ROOT element. If it is determined that the current element is the ROOT element, then at process block 222, the root element's type information object is stored and preparations are made to build the XML schema document. Alternatively, if the current element is not the ROOT element, then the process moves back through point A to process block 202. As such, additional events are parses and processed at process clock 202.

At decision block 203, if it is determined that the current element type is a CHAR DATA element, then the process moves to process block 223. At process block 224, the character data is extracted from the current element, and the character data is analyzed to determine the character data's type. In one embodiment, the character data type may include a DAT, a BOOLEAN, a FLOAT, an INTEGER, a STRING, etc. Then, at process block 225, the current element's type information object is picked 228 from the stack 229. Then, the current element's type information object's data type is set to the determined data type of the CHAR DATA.

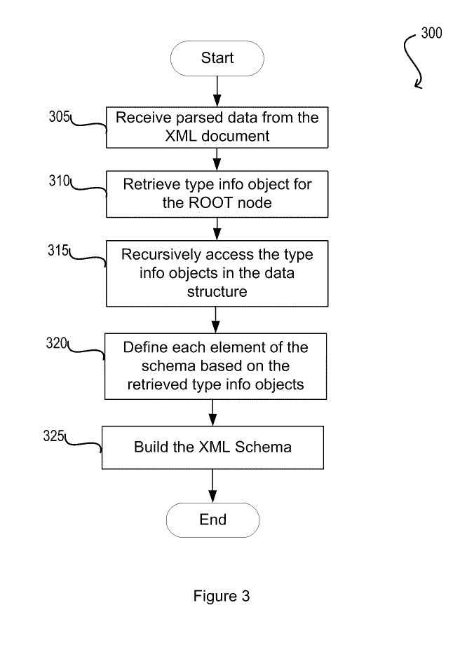

Accordingly, after process block 225, the process moves back through point A to process block 202 in order to continue to read the XML document and return events. This process continues until the ROOT element's END TAG is returned and the process moves to process block 22, and completes the process. Then, at FIG. 3, the XML schema document is built from the type information objects data structure. In one embodiment, one of the following schema constructs shall be used to represent each type in the information object data structure created by the process of FIG. 2:

```
1. Element that has only attributes no child elements or no data.
<xs:element name=“product”>
    <xs:complexType>
        <xs:attribute name=“prodid” type=“xs:positiveInteger”/>
    </xs:complexType>
</xs:element>
2. Element has only attributes and data but no child elements
<xs:element name=“shoesize”>
    <xs:complexType>
        <xs:simpleContent>
            <xs:extension base=“xs:integer”>
                <xs:attribute name=“country” type=“xs:string” />
            </xs:extension>
        </xs:simpleContent>
    </xs:complexType>
</xs:element>
3. Element has only data no attributes and no elements.
<xs:element name=“name” type = “xs:string”/>
4. Element has child element within.
<xs:element name=“product”>
    <xs:complexType>
        <sequence>
            <element name=...
        </sequence>
    </xs:complexType>
</xs:element>
5. Element has child element and text data.
<xs:element name=“product”>
    <xs:complexType mixed = “true”>
        <sequence>
            <element name=...
        </sequence>
    </xs:complexType>
</xs:element>
6. Element has child Element and attributes
<xs:element name=“product”>
    <xs:complexType>
        <sequence>
            <element name=...
            <element name=...
        </sequence>
        <attribute name= ...
        <attribute name= ...
    </xs:complexType>
</xs:element>
```

Referring now to FIG. 3, which illustrates a method 300 for building an XML schema, according to an embodiment of the present invention. In one embodiment, in this phase, the parsed data is used to build a new XML schema for the XML document. The ROOT type information object is retrieved and each child is recursively accessed to extract all the child elements and the attribute definitions.

At process block 305, the parsed data generated in FIG. 2 from the XML document is retrieved. At process block 310, the ROOT node type information object is retrieved. Then at process block 315, each of the child type information objects are recursively accessed and each element of the schema is defined based on the retrieved type information objects (process block 320) by matching each type information object with one of the six schema constructs described above. Accordingly, the XML schema for the inputted XML document is built. As such, the manual user-intensive process of generating such an XML schema is replaced with the automated process described in methods 100, 200, and 300. In one embodiment, the completed XML schema may be similar to the following:

```
<xsd:schema xmlns:xsd=″http://www.w3.org/2001/XMLSchema″
          xmlns=″TargetNS″
          targetNamespace=″TargetNS″
          elementFormDefault=″qualified″>
  <xsd:element name=″employees″>
    <xsd:complexType>
      <xsd:sequence>
        <xsd:element name=″employee″>
          <xsd:complexType>
            <xsd:sequence>
              <xsd:element name=″name″>
                <xsd:complexType>
                  <xsd:attribute name=”firstName” type=”xsd:stirng”/>
                  <xsd:attribute name=”lastName” type=”xsd:stirng”/>
                </xsd:complexType>
              </xsd:element>
            <xsd:element name=″hiredate″ type=″xsd:date″/>
          <xsd:element name=″salary″ type=″xsd:float″/>
        <xsd:element name=″age″ type=″xsd:integer″/>
      </xsd:sequence>
    </xsd:complexType>
  </xsd:element>
    </xsd:sequence>
    <xsd:attribute name=”orgName” type=”xsd:string”/>
    </xsd:complexType>
  </xsd:element>
</xsd:schema>
```

Furthermore, if the enumerations option was set, then the XML schema may be similar to the following XML schema:

```
<xsd:attribute name=”firstName”>
  <xsd:simpleType>
    <xsd:restriction base=”xsd:string”>
      <xsd:enumeration value=”Scott”/>
    </xsd:restriction>
  </xsd:simpleType>
</xsd:attribute>
```

In the case in which generation of enumerations is enabled as an input argument, the element definitions are added with a restriction tag with allowed enumeration. For example, “firstName” and similar others in the above example are generated.

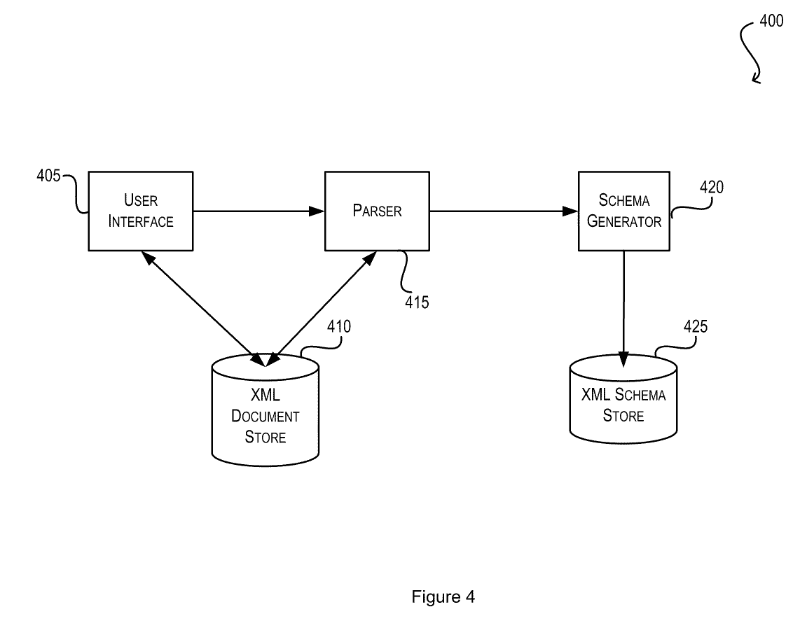

Turning now to FIG. 4, which illustrates a system 400 for implementing aspects of the present invention, according to a further embodiment of the present invention. System 400 may be used to implement methods 100, 200, or 300 (described above). In one embodiment, system 400 may include a user interface 405. The user interface 305 may be used to receive input from a user or administer (e.g., the XML schema path, the XML document path, options, etc.).

The system 400 may further include an XML document store 410 in communication with the user interface 405 and a parser 415. The XML document store may be configured to store the XML document for which the XML schema is to be generated. Further, the parser 415 may be configured to implement aspects of the method 200 in FIG. 2. Accordingly, the parser 415 may be configured to extract events from the XML document. The extracted events may then be passed to a schema generated 420. As such, schema generator may be configured to implement aspects of method 200 and method 300. Furthermore, the generated XML schema may then be stored in an XML schema store 425.

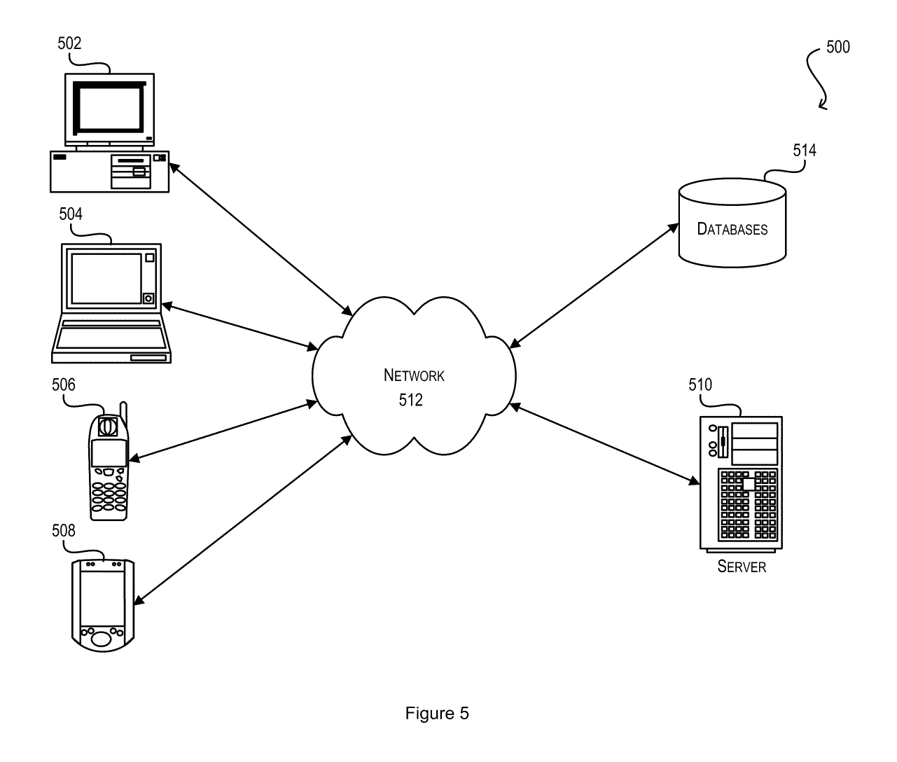

FIG. 5 is a simplified block diagram illustrating physical components of a system environment 500 that may be used in accordance with an embodiment of the present invention. This diagram is merely an example, which should not unduly limit the scope of the claims. One of ordinary skill in the art would recognize many variations, alternatives, and modifications.

As shown, system environment 500 includes one or more client computing devices 502, 504, 506, 508 communicatively coupled with a server computer 510 via a network 512. In one set of embodiments, client computing devices 502, 504, 506, 508 may be configured to run one or more components of a graphical user interface described above. For example, client computing devices allow user to create and customize network communities, enter search queries, view search results, and others.

Client computing devices 502, 504, 506, 508 may be general purpose personal computers (including, for example, personal computers and/or laptop computers running various versions of Microsoft Windows™ and/or Apple Macintosh™ operating systems), cell phones or PDAs (running software such as Microsoft Windows™ Mobile and being Internet, e-mail, SMS, Blackberry™, and/or other communication protocol enabled), and/or workstation computers running any of a variety of commercially available UNIX™ or UNIX™-like operating systems (including without limitation the variety of GNU/Linux™ operating systems). Alternatively, client computing devices 502, 504, 506, and 508 may be any other electronic device capable of communicating over a network (e.g., network 512 described below) with server computer 510. Although system environment 500 is shown with four client computing devices and one server computer, any number of client computing devices and server computers may be supported.

Server computer 510 may be a general purpose computer, specialized server computer (including, e.g., a LINUX™ server, UNIX™ server, mid-range server, mainframe computer, rack-mounted server, etc.), server farm, server cluster, or any other appropriate arrangement and/or combination. Server computer 510 may run an operating system including any of those discussed above, as well as any commercially available server operating system. Server computer 510 may also run any of a variety of server applications and/or mid-tier applications, including web servers, Java virtual machines, application servers, database servers, and the like. In various embodiments, server computer 510 is adapted to run one or more Web services or software applications described in the foregoing disclosure. For example, server computer 510 is specifically configured to implement enterprise procurement systems described above.

As shown, client computing devices 502, 504, 506, 508 and server computer 510 are communicatively coupled via network 512. Network 512 may be any type of network that can support data communications using any of a variety of commercially-available protocols, including without limitation TCP/IP, SNA, IPX, AppleTalk™, and the like. Merely by way of example, network 512 may be a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g., a network operating under any of the IEEE 802.11 suite of protocols, the Bluetooth™ protocol known in the art, and/or any other wireless protocol); and/or any combination of these and/or other networks. In various embodiments, the client computing devices 502, 504, 506, 508 and server computer 510 are able to access the database 514 through the network 512. In certain embodiments, the client computing devices 502, 504, 506, 508 and server computer 510 each has its own database.

System environment 500 may also include one or more databases 514. Database 514 may correspond to an instance of integration repository as well as any other type of database or data storage component described in this disclosure. Database 514 may reside in a variety of locations. By way of example, database 514 may reside on a storage medium local to (and/or resident in) one or more of the computing devices 502, 504, 506, 508, or server computer 510. Alternatively, database 514 may be remote from any or all of the computing devices 502, 504, 506, 508, or server computer 510 and/or in communication (e.g., via network 512) with one or more of these. In one set of embodiments, database 514 may reside in a storage-area network (SAN) familiar to those skilled in the art. Similarly, any necessary files for performing the functions attributed to the computing devices 502, 504, 506, 508, or server computer 510 may be stored locally on the respective computer and/or remotely on database 514, as appropriate. For example, the database 514 stores user profiles, procurement information, attributes associated with network entities.

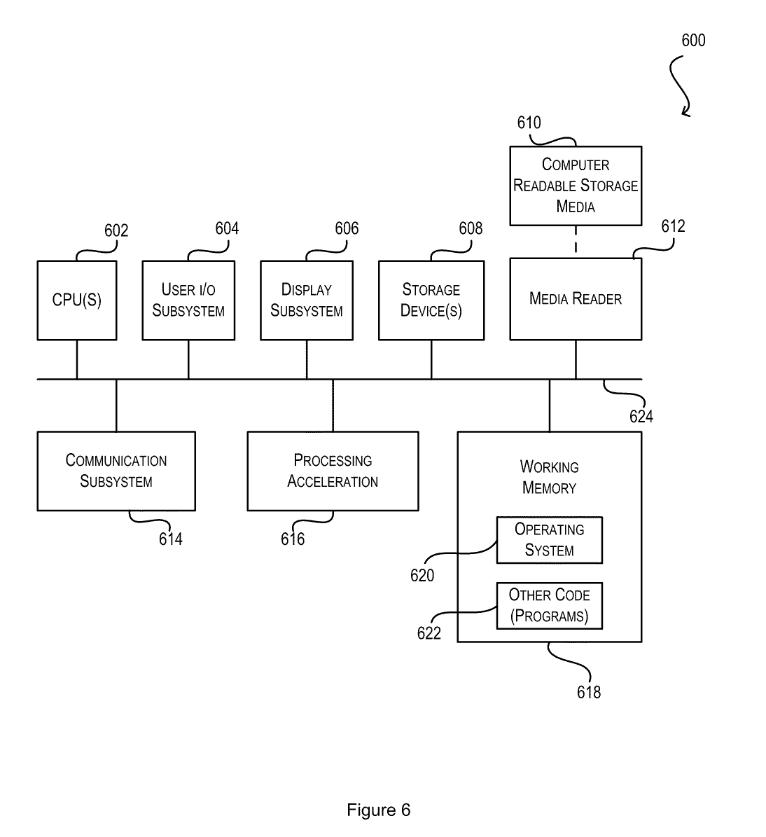

FIG. 6 is a simplified block diagram illustrating the physical components of a computer system 600 that may be used in accordance with an embodiment of the present invention. This diagram is merely an example, which should not unduly limit the scope of the claims. One of ordinary skill in the art would recognize many variations, alternatives, and modifications.

In various embodiments, computer system 600 may be used to implement any of the computing devices 502, 504, 506, 508, or server computer 510 illustrated in system environment 500 described above. As shown in FIG. 6, computer system 600 comprises hardware elements that may be electrically coupled via a bus 624. The hardware elements may include one or more central processing units (CPUs) 602, one or more input devices 604 (e.g., a mouse, a keyboard, etc.), and one or more output devices 606 (e.g., a display device, a printer, etc.). For example, the input devices 604 are used to receive user inputs for procurement related search queries. Computer system 600 may also include one or more storage devices 608. By way of example, storage devices 608 may include devices such as disk drives, optical storage devices, and solid-state storage devices such as a random access memory (RAM) and/or a read-only memory (ROM), which can be programmable, flash-updateable and/or the like. In an embodiment, various databases are stored in the storage devices 608. For example, the central processing unit 602 is configured to retrieve data from a database and process the data for displaying on a GUI.

Computer system 600 may additionally include a computer-readable storage media reader 612, a communications subsystem 614 (e.g., a modem, a network card (wireless or wired), an infra-red communication device, etc.), and working memory 618, which may include RAM and ROM devices as described above. In some embodiments, computer system 600 may also include a processing acceleration unit 616, which can include a digital signal processor (DSP), a special-purpose processor, and/or the like.

Computer-readable storage media reader 612 can further be connected to a computer-readable storage medium 610, together (and, optionally, in combination with storage devices 608) comprehensively representing remote, local, fixed, and/or removable storage devices plus storage media for temporarily and/or more permanently containing computer-readable information. Communications system 614 may permit data to be exchanged with network 512 of FIG. 5 and/or any other computer described above with respect to system environment 500.

Computer system 600 may also comprise software elements, shown as being currently located within working memory 618, including an operating system 620 and/or other code 622, such as an application program (which may be a client application, Web browser, mid-tier application, RDBMS, etc.). In a particular embodiment, working memory 618 may include executable code and associated data structures for one or more of the design-time or runtime components/services. It should be appreciated that alternative embodiments of computer system 600 may have numerous variations from that described above. For example, customized hardware might also be used and/or particular elements might be implemented in hardware, software (including portable software, such as applets), or both. Further, connection to other computing devices such as network input/output devices may be employed. In various embodiments, the behavior of the view functions described throughout the present application is implemented as software elements of the computer system 600.

In one set of embodiments, the techniques described herein may be implemented as program code executable by a computer system (such as a computer system 600) and may be stored on machine-readable media. Machine-readable media may include any appropriate media known or used in the art, including storage media and communication media, such as (but not limited to) volatile and non-volatile, removable and non-removable media implemented in any method or technology for storage and/or transmission of information such as machine-readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store or transmit the desired information and which can be accessed by a computer.

Although specific embodiments of the present invention have been described, various modifications, alterations, alternative constructions, and equivalents are within the scope of the invention. Further, while embodiments of the present invention have been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method of generating an XML schema, the method comprising:
receiving, at a computer system, an XML document;
extracting, by the computer system, a first event from the XML document;
determining that the first event's event type comprises an element start tag;
determining that the first element comprises the XML document's root element;
based in part on the first element comprising the root element and the event type comprising an element start tag, creating a root type information object;
pushing the first type information object on a stack stored on a storage device of the computer system;
setting the first type information object as a current element;
extracting attribute information for the current element;
inserting the attribute information into the current information type objection;
extracting a second event from the XML document;
determining that the second event type comprises an element end tag;
popping the current element from the stack;
determining that the current element comprises the root element; and
based on the root type information object, constructing the XML schema.

2. A method of generating an XML schema as in claim 1, the method comprising:
extracting a second event from the XML document;
determining that the second element's event type comprises an element start tag and that the second element comprises a child element;
based in part on the second element's event type comprising an element start tag and comprising a child element, extracting the second element's parent type information from the stack, wherein the parent type information comprises the root element;
creating a child type information object;
pushing onto the stack the child type information object;
adding the child type information object's type information to the first type information object;
setting the type information object as the current type information object;
extracting attribute information for the current type information object; and
for each attribute creating a type information object and adding each type information object to the current type information object.

3. A method of generating an XML schema as in claim 2, the method comprising:
extracting a third element from the XML document;
determining that the third element's element type comprises an element end tag;
popping the current type information object in from the stack;
setting a maximum occurrence and a minimum occurrence value for the current type information object;
in response to determining that the current type information object's object type is not the root type information object, continuing to extract events from the XML document and creating new type information objects; and
inserting the type information objects into the XML schema.

4. A method of generating an XML schema as in claim 3, wherein the maximum occurrence value is used to determine a maximum number of times an element is to appear in the XML schema.

5. A method of generating an XML schema as in claim 3, wherein the minimum occurrence value is used to determine a minimum number of times an element is to appear in the XML schema.

6. A method of generating an XML schema as in claim 2, the method comprising:
extracting a third element from the XML document;
determining that the third element's element type comprises character data;
analyzing the character data to determine the character data's type; and
setting the current type information element's character data type as the character data's type.

7. A method of generating an XML schema as in claim 6, wherein the character data type comprises one or more of the following: a date, a Boolean value, a float, an integer, and a string.

8. A method of generating an XML schema, the method comprising:
parsing an XML document to extract event elements;
for each element event, determining the event element's type;
based on the event type of the event element, generating a type information object and inserting attribute information from the event element into each of the type information objects, wherein the type information objects are generated for a root element and child elements until the event element's type comprises the root element end tag; and
based on the generated type information objects and the corresponding attribute information, building the XML schema.

9. A method of generating an XML schema as in claim 8, wherein the event element type comprises on or more of the following: a start tag, an end tag, and character data.

10. A method of generating an XML schema as in claim 8, wherein a maximum occurrence value is used to determine a maximum number of times an element is to appear in the XML schema.

11. A method of generating an XML schema as in claim 9, wherein a minimum occurrence value is used to determine a minimum number of times an element is to appear in the XML schema.

12. A machine-readable medium having sets of instructions stored thereon which, when executed by a machine, cause the machine to:
receive an XML document;
extract a first event from the XML document;
determine that the first event's event type comprises an element start tag;
determine that the first element comprises the XML document's root element;
based in part on the first element comprising the root element and the event type comprising an element start tag, create a root type information object;
push the first type information object on a stack stored on a storage device of the computer system;
set the first type information object as a current element;
extract attribute information for the current element;
insert the attribute information into the current information type objection;
extract a second event from the XML document;
determine that the second event type comprises an element end tag;
pop the current element from the stack;
determine that the current element comprises the root element; and
based on the root type information object, construct the XML schema.

13. A machine-readable medium as in claim 12, wherein the sets of instructions which, when further executed by the machine, cause the machine to:
extract a second event from the XML document;
determine that the second element's event type comprises an element start tag and that the second element comprises a child element;
based in part on the second element's event type comprising an element start tag and comprising a child element, extract the second element's parent type information from the stack, wherein the parent type information comprises the root element;
create a child type information object;
push onto the stack the child type information object;
add the child type information object's type information to the first type information object;
set the type information object as the current type information object;
extract attribute information for the current type information object; and
for each attribute create a type information object and add each type information object to the current type information object.

14. A machine-readable medium as in claim 13, wherein the sets of instructions which, when further executed by the machine, cause the machine to:
extract a third element from the XML document;
determine that the third element's element type comprises an element end tag;
pop the current type information object in from the stack;
set a maximum occurrence and a minimum occurrence value for the current type information object;
in response to determining that the current type information object's object type is not the root type information object, continue to extract events from the XML document and create new type information objects; and
insert the type information objects into the XML schema.

15. A machine-readable medium as in claim 12, wherein the maximum occurrence value is used to determine a maximum number of times an element is to appear in the XML schema.

16. A machine-readable medium as in claim 12, wherein the minimum occurrence value is used to determine a minimum number of times an element is to appear in the XML schema.

17. A machine-readable medium as in claim 13, wherein the sets of instructions which, when further executed by the machine, cause the machine to:
extract a third element from the XML document;
determine that the third element's element type comprises character data;
analyze the character data to determine the character data's type; and
set the current type information element's character data type as the character data's type.

18. A machine-readable medium as in claim 17, wherein the character data type comprises one or more of the following: a date, a Boolean value, a float, an integer, and a string.
